(19) United States
(12) Patent Application Publication
(10) Pub. No.: US 2016/0224741 A1
(43) Pub. Date: Aug. 4, 2016

(54) DATA INPUT METHOD

(71) Applicant: iSOFT Applications Limited, Oxfordshire (GB)

(72) Inventors: Satya Kaliki, Chennai (IN); Seetharam Malur, Chennai (IN); Chris Tackaberry, London (GB); Christopher Marshall, Manchester (GB); Clement Jeyaraj, Chennai (IN)

(73) Assignee: iSOFT Applications Limited, Oxfordshire (GB)

(21) Appl. No.: 15/091,940

(22) Filed: Apr. 6, 2016

Related U.S. Application Data
(63) Continuation of application No. 12/293,414, filed on Sep. 10, 2009.

(30) Foreign Application Priority Data
Mar. 18, 2006 (GB) 0605484.5

(51) Int. Cl. G06F 19/00; G06F 3/0482; G06F 17/30; G06F 3/0481

(52) U.S. Cl. CPC G06F 19/345; G06F 3/04817; G06F 3/0482; G06F 19/322; G06F 17/30525

(57) ABSTRACT

A computer implemented method of presenting information indicating a quantity of data held relating to a data subject. The method comprises processing data associated with the data subject to generate data indicating one of a predetermined set of classes, each class representing a range of predetermined quantities of data, and displaying data indicating the class.

### CROSS-REFERENCE TO RELATED APPLICATIONS

This application is a continuation of U.S. patent application Ser. No. 12/293,414, filed Sep. 10, 2009 and entitled “Data Input Method,” which is a national stage application pursuant to 35 U.S.C. §371 of International Application No. PCT/GB2007/000957, filed Mar. 19, 2007, which claims priority to Great Britain Patent Application No. 0605484.5, filed Mar. 18, 2006, the disclosures of which are hereby incorporated by reference herein.

### DESCRIPTION

The present invention relates to a computer implemented data input method. The invention also relates to a method of presenting information indicating a quantity of data held relating to a data subject.

Computers are now ubiquitous in modern society. They are used in many different applications, including by individuals in their homes and their places of work. In many commercial applications there is a need for computer systems which efficiently receive, process and store data. In many applications it is important that data is handled resiliently, reliably and securely. The security requirements of many applications require not only that access to data is closely controlled, but also that data is handled in such a way as to avoid data corruption.

In recent years, much attention has been focused on the way in which humans interact with computers. Indeed, much research has been carried out in an area known as human-computer interaction. When computers first became popular, they provided interfaces which were primarily or solely text based. More recently graphical user interfaces have become widely used. Considerable research continues to be carried out so as to devise user interfaces which allow users to more efficiently interact with computers.

According to a first aspect of the present invention, there is provided, a computer implemented method of presenting information indicating a quantity of data held relating to a data subject, the method comprising: processing data associated with said data subject to generate data indicating one of a predetermined set of classes, each class representing a range of predetermined quantities of data, and displaying data indicating said class.

According to a further aspect of the present invention, there is provided, a computer implemented data input method comprising: receiving textual input data, processing said textual input data to identify one of a predetermined plurality of data categories, selecting a data item associated with said identified data category, and storing said selected data item.

According to a further aspect of the present invention, there is provided, a computer implemented data input method comprising: receiving textual input data comprising first textual input data and second textual input data, processing said first textual input data, and storing said second textual input data in a manner based upon said processing.

Embodiments of the present invention will now be described, by way of example only, with reference to the accompanying drawings, in which:

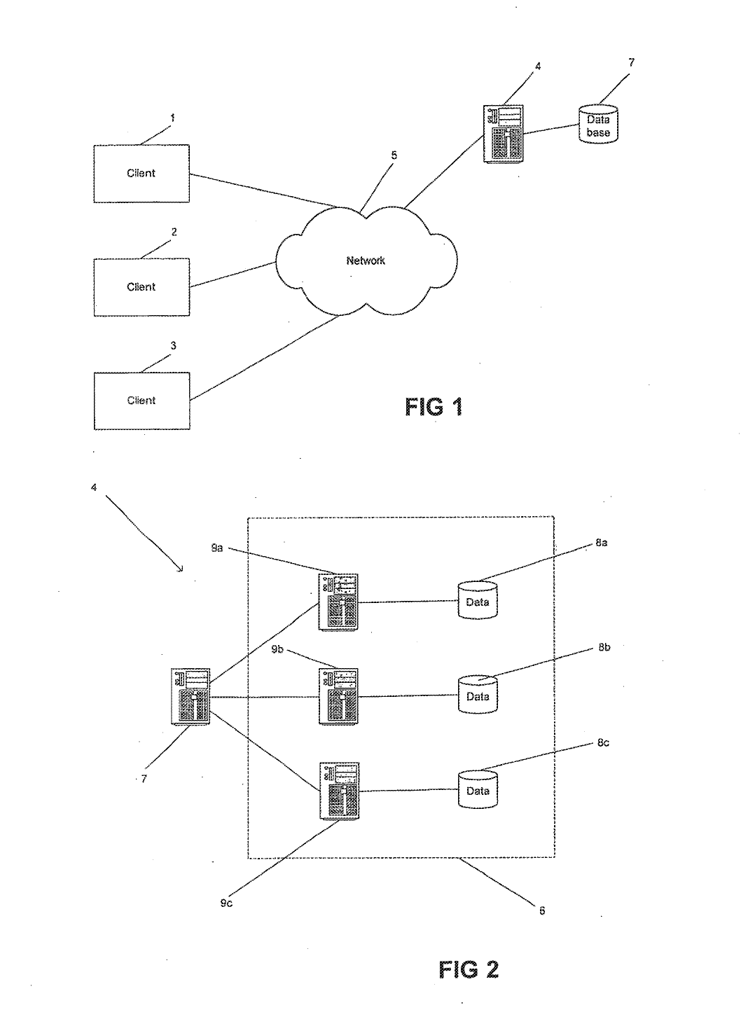

FIG. 1 is an overview of a network of computers used to implement embodiments of the present invention;

FIG. 2 is a schematic illustration showing the server of FIG. 1 in further detail;

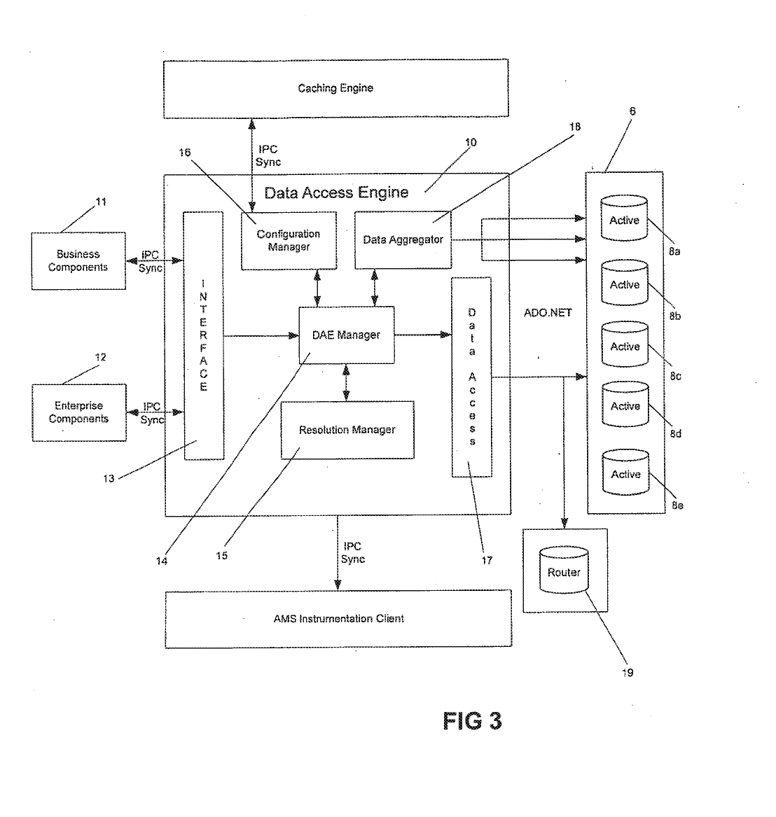

FIG. 3 is a schematic illustration of a database access control architecture used in embodiments of the present invention;

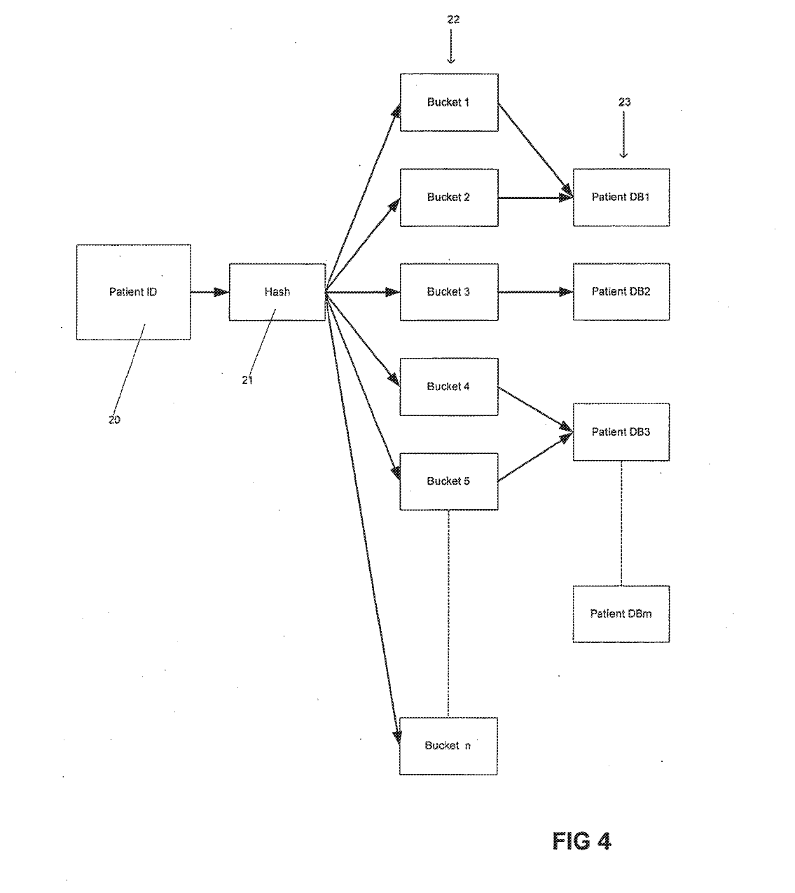

FIG. 4 is a schematic illustration of a hash algorithm used in the architecture of FIG. 3;

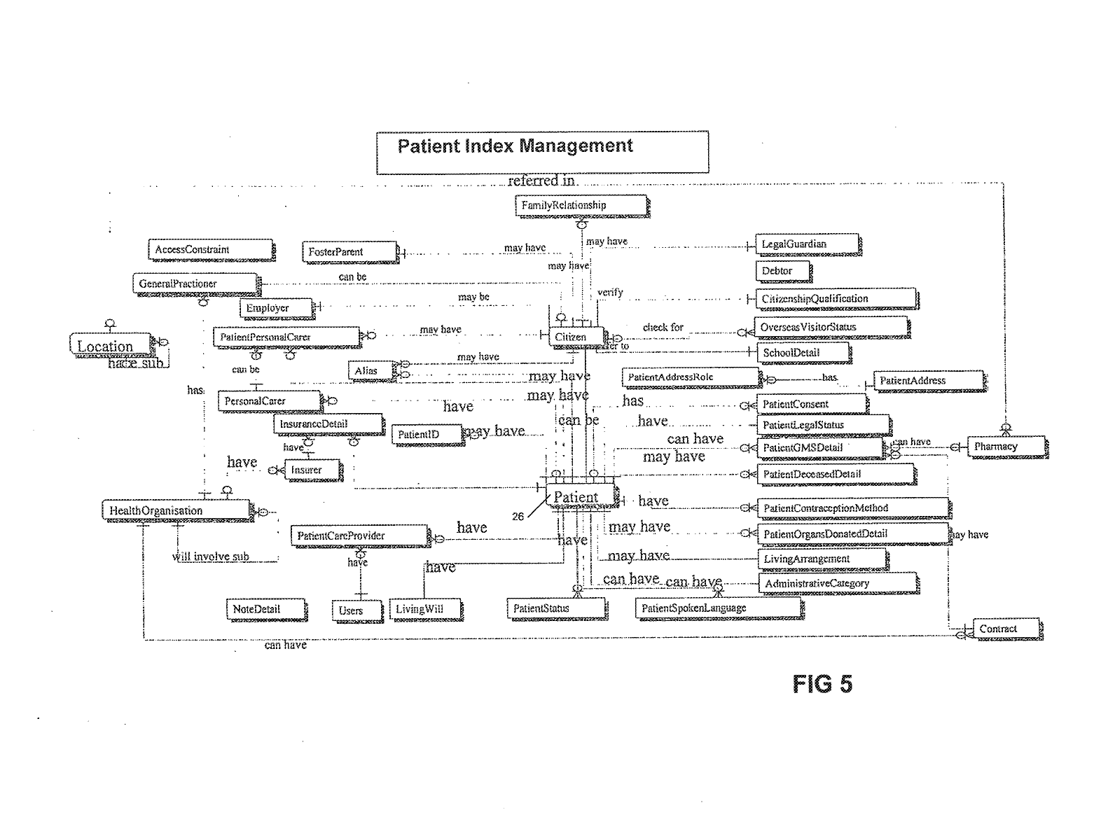

FIG. 5 is a partial illustration of a database schema;

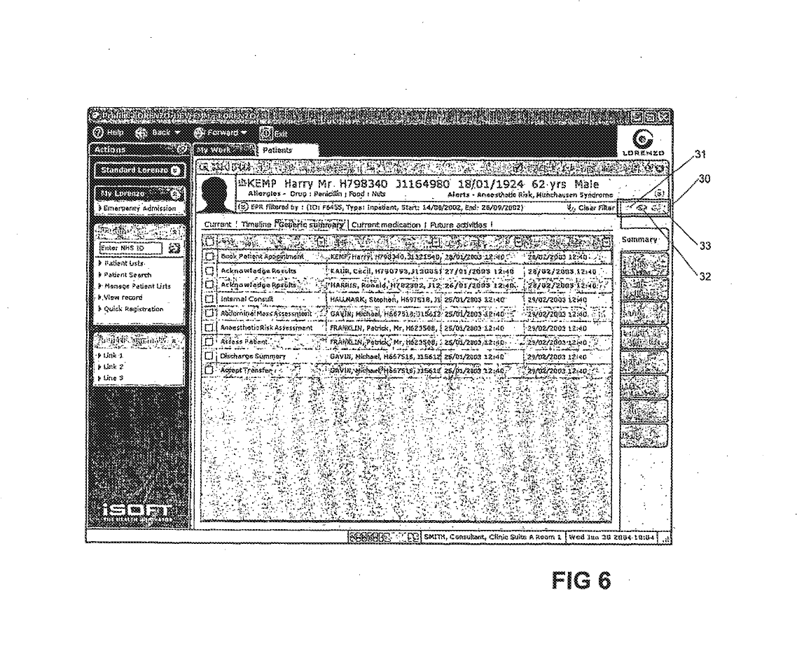

FIG. 6 is a schematic illustration of a Graphical User Interface (GUI) used in embodiments of the present invention to display data indicative of a quantity of data relating to a data subject;

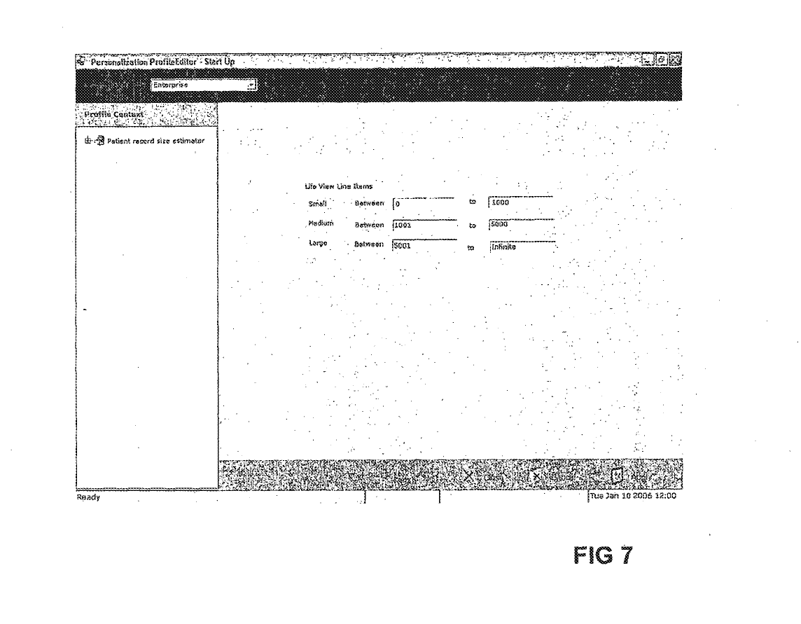

FIG. 7 is a schematic illustration of a GUI used in embodiments of the present invention to control the display of FIG. 3;

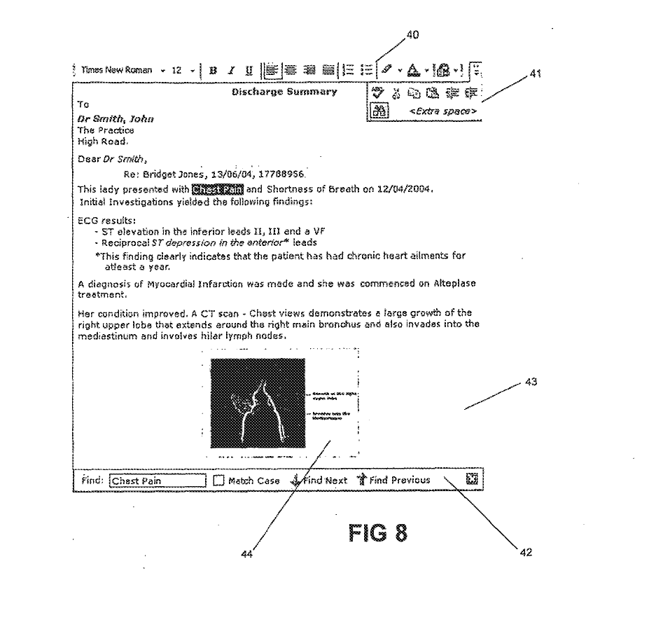

FIG. 8 is a screenshot of a text input screen provided in embodiments of the invention;

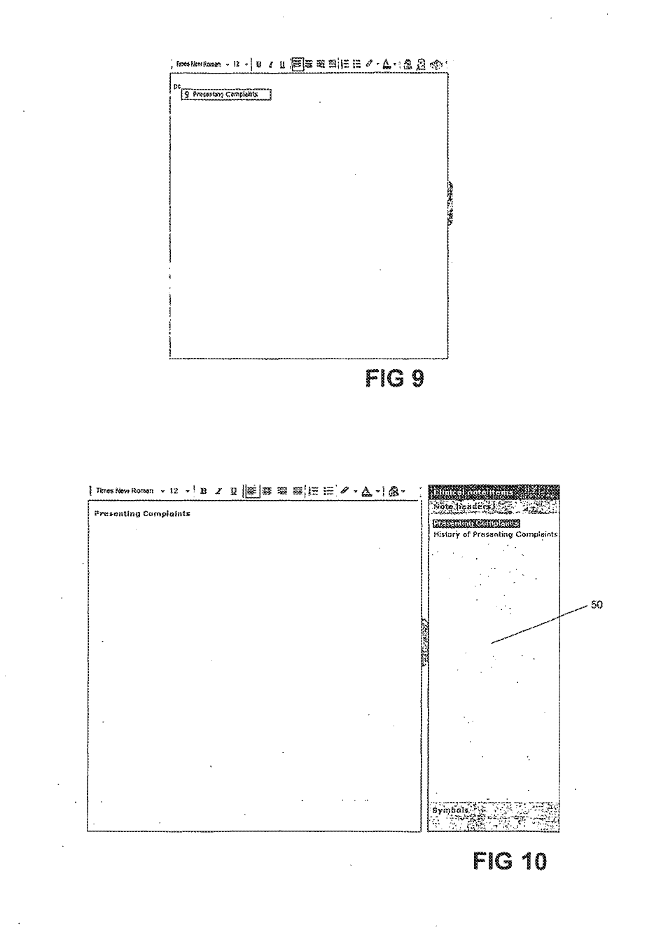

FIGS. 9 and 10 are screenshots showing how headings can be used in the textual data input screen of FIG. 8; and

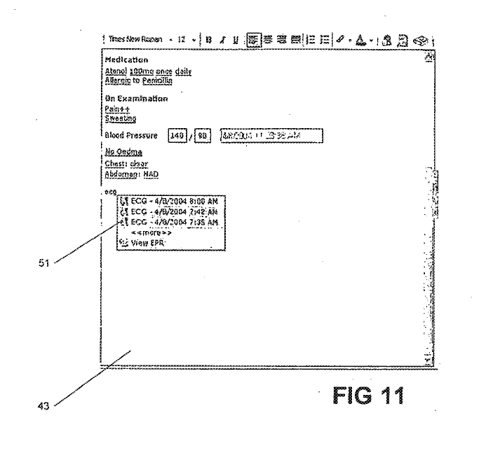

FIG. 11 is a screenshot showing how tags can be used to assist data input.

Referring to FIG. 1, there is illustrated a network of computers suitable for implementing embodiments of the present invention. It can be seen that three client computers 1, 2, 3 access services provided by a server 4 over a network 5.

The client computers 1, 2, 3 can take any convenient form. For example in some embodiments some client computers 1, 2, 3 take the form of desktop computers, others take the form of laptops, while others take the form of tablet PCs. However the client computers can also take the form of mobile devices such as mobile telephony devices or PDAs.

The network 5 can be any suitable network which provides effective communication between the client computers 1, 2, 3 and the server 4. For example the network 5 can be a wired or wireless local area network (LAN). Alternatively the network 5 may comprise a wide area network such as the Internet. In such a case, the network 5 may further comprise a plurality of LANs connected to the wide area network, the client computers 1, 2, 3 in turn being connected to the LANs, and through the LANs being able to communicate over the wide area network.

The server 4 can be a single computer or more typically a plurality of computers. It will be appreciated that where a plurality of computers are provided to form the server 4, services provided by the server 4 can be distributed between the computers in any convenient manner.

The client computers 1, 2, 3 run client applications which communicate with the server 4. For example, the server 4 may provide a logical data store 6. Access to the logical data store 6 may be controlled by the server 4, such that by communicating with the programs running on the server 4, the client computers 1, 2, 3 are able to access the logical data store 6. FIG. 2 illustrates an example architecture for the server 4.

Referring to FIG. 2, it can be seen that a server computer 7 communicates with and controls access to the logical data store 6. It can be seen that the logical data store 6 is provided in three data stores 8a, 8b, 8c, each of which is connected to a respective database server 9a, 9b, 9c. The server computer 7 communicates with the database servers 9a, 9b, 9c to access and amend data stored in the data stores 8a, 8b, 8c.

The described embodiments have particular applicability in healthcare environments. In such environments (as in many others) data security is very important, both from the point of view of controlling data access, and from the point of view of ensuring that data is not lost or corrupted. An architecture suitable for managing access to healthcare data is now described with reference to FIG. 3.

Referring to FIG. 3, it can be seen that the logical data store 6 here comprises five individual data stores 8a, 8b, 8c, 8d, 8e. These data stores are arranged so as to provide efficient and effective access to data stored in the logical data store 6. For example, where patient data is stored, it is preferred that all data relating to a particular patient is stored within a single one of the data stores 8a to 8e. It can be seen that a data access engine (DAE) 10 is provided to control access to the data stores 8a to 8e. Client applications wishing to access data stored in the data stores 8a to 8e use the DAE 10 to achieve such access. Such client applications can be run on the client computers 1, 2, 3 of FIG. 1. It can be seen that client applications can include business components 11 and enterprise components 12, both of which access data using the data access engine 10.

Components of the data access engine 10 are now described. In preferred embodiments, the DAE is implemented using Microsoft® NET framework. The NET framework provides a set of classes referred to as ADO.NET which provide convenient functionality for database access. The DAE 10 accesses the data stores 8a to 8e using functionality provided by the ADO.NET classes. The DAE 10 abstracts the data persistence and data retrieval mechanisms of ADO.NET. To achieve this generic ADO.NET data access methods are wrapped so as to encapsulate the execution functionality for Oracle databases and SQL Server databases as appropriate. It will be appreciated that other databases could also be used.

It can be seen that the DAE 10 comprises an interface 13, and it is through this interface that both business components 11 and enterprise components 12 communicate with the DAE to access data. The interface 13 defines constants and provides business components 11 and enterprise components 12 with access to a DAE manager 14.

The DAE manager 14 is responsible for managing data access operations. The DAE manager 14 interacts with a resolution manager component 15, a configuration manager component 16, a data access component 17 and a data aggregator component 18. The function of these components is now described.

The configuration manager component 16 is responsible for providing configuration information. The configuration manager is a singleton class, that is a class having a single instance for a particular physical server. The configuration manager component 16 receives as input two Extensible Markup Language (XML) files containing configuration information.

The resolution manager component 15 is invoked to obtain details of a database server on which a particular query should be executed. This process can be carried out in a number of ways. For example, configuration files provided to the configuration manager component 16 can specify a database server to be associated with each class. By obtaining the identifier of the class associated with a particular query, the configuration manager can be used by the resolution manager component 15 to determine which database server should be accessed.

Alternatively, a router database 19 can be used as an index to the data stores 8a to 8e. Where data is stored in a patient centric manner (i.e. in a manner associated with a particular patient), the router database 19 will use data associated with a particular patient to identify one or more of the data stores 8a to 8e on which relevant data is stored. In this way, the resolution manager component 15 uses the router database 19 to determine which of the data stores should be used to obtain necessary information.

The router database 19 can function well where data to be retrieved is patient centric data. Given that some information in healthcare systems is not patient centric (e.g. information relating to the healthcare institution) data can have an associated attribute indicating whether or not it is patient centric data. This attribute is referred to as a Partition Qualifier. By using the Partition Qualifier the resolution manager component 15 is able to first determine whether required data is patient centric data. If this is not the case, one or more data stores holding non-patient centric data are queried. If however the data is patient centric data, the router database 19 can be used in the manner described above to identify appropriate data stores to be queried.

Although using the router database 19 in the manner described above provides effective access to data stored within the logical data store 6, it will be appreciated that repeated access to the router database 19 can be a source of inefficiency. The resolution manager 15 can therefore use a cache to prevent over-frequent access of the router database 19. A cache is used to store connection strings for each data store of interest. The cache stores a map which maps bucket identifiers generated by a hashing algorithm (described below) to connection strings. An appropriate connection string is identified using a bucket identifier generated by a hashing algorithm as is described below with reference to FIG. 4.

Referring to FIG. 4 it can be seen that a patient identifier 20 is input to a hashing algorithm 21. The output of the hashing algorithm 21 is a bucket identifier 22. The cache described above stores a map mapping bucket identifiers 22 to connection strings 23, each connection string 23 being configured to connect to a particular data store. Each bucket identifier is associated with a single data store, although more than one bucket can be associated with any one data store.

The patient identifier 20 input to the hashing algorithm 21, and more generally the patient identifier used to process patient centric requests can take any convenient form. For example, a numeric or alphanumeric identifier uniquely allocated to each patient by a healthcare institution or a health service (such as the National Health Service in the UK) can suitably be used. Having determined an identifier which is to be used as the patient identifier 20, the hashing algorithm is configured to work with this identifier.

Referring back to FIG. 3, the data aggregator component 18 of the DAE 10 is an optional component. When a client application makes a data request which requires data to be retrieved from a plurality of data stores, the DAE manager 14 interacts with the data aggregator component 18 to ensure that appropriate data requests are made to appropriate data stores. The data aggregator component is a multi-threaded component, with a user configurable number of threads.

The data access component 17 is responsible for all communications with the data stores, and appropriately wraps ADO.NET execution methods. The data access component 17 is implemented using an abstract factory pattern. Helper instances are implemented which are specific to databases which are to be accessed. Helper instances can execute stored procedures or ad-hoc queries for update, select and delete database operations.

It can be seen that the DAE 10 further communicates with a caching engine 24 and an Application Monitoring Service (AMS) instrumentation client 25. The caching engine 24 provides a cache for use by the configuration manager component 16. The AMS instrumentation client 25 provides facilities to instrument the operations for various concerns, as specified by requirements.

It will be appreciated that patient centric data stored in the data stores 8a to 8e stores a wide variety of data relating to patients whose data is to be processed. Data is stored in database tables in a manner which will be well known to those skilled in the art. FIG. 5 shows part of a database schema centered around a patient table 26. It can be seen that relationships are illustrated between the patient table 25 and various other tables which store patient demographic data. The patient table 25 stores data relevant to particular patients such as name data, date of birth data and gender data.

Other tables of the database (some of which are illustrated in FIG. 5) also store data relating to particular patients. These tables relate their data to a particular patient by having a foreign key field which targets the primary key of the patient table.

When patient data is stored electronically, it is difficult for a medical practitioner to get a quick indication of the quantity of data stored relating to a particular patient. This indication can often be useful, given that patients on whom a great deal of data is stored are likely to have a longer and/or more complex medical history than those on which relatively little data is stored. This indication can therefore be a useful introductory indicator to a medical practitioner.

In preferred embodiments all patient records (where a patient record contains all data stored which relates to a particular patient) have an associated classification as small, medium or large based upon the quantity of data stored relating to that patient.

It has been described above that the database includes a patient table 25 which has as its primary key a unique patient identifier. It has also been explained that this key is used to identify data in other tables which relates to a particular table. In this way it is possible to determine how much data is stored about a particular patient by simply counting records in a plurality of database tables which refer to the patient identifier. That is, all appropriate database tables have a patient field storing data which indicates a particular patient using a patient identifier. By querying all tables to identify records having a patient field set to a predetermined patient identifier, all records associated with the predetermined patient identifier can be identified, and a count of such records, across all appropriate tables, can be carried out.

In some embodiments, appropriate database tables in which records are counted using the method described above are shown in Table 1 below.

TABLE 1
Table Name

CCDocument
PatientAssessment
PatientClinicalNote
PatientProblem
Encounter
Patient
Referral
ReferralStatus
Prescription
Request
PatientObservation
Result
PatientAlert
PatientAllergy
PatientAppointment
PatientProcedure

It will be appreciated that by counting records relating to a particular patient in all tables shown in table 1 above a good indication of a quantity of data stored which is associated with the particular patient is obtained. This equates, approximately, to the likely thickness of a paper file associated with the patient.

FIG. 6 is a screenshot taken from an embodiment of the invention. It can be seen that an area 30 includes three icons. These icons represent the small, medium and large classifications for patient records described above. It can be seen that in the case illustrated in FIG. 6 a first icon 31 representing the small classification is shown in a first highlighted state, while second icons 32, 33 are shown in a second greyed out states. In this way, although three icons are always displayed, one of the three icons is highlighted to show the size indicator associated with a particular patient.

It has been described that the manner of selecting one of the small, medium and large classifications involves counting a number of records relating to a particular patient in various database tables. It will be appreciated that having carried out this count, it is necessary to translate the absolute number of records to one of the three classifications. This can be carried out by specifying ranges of numbers of records which respectively correspond to the small, medium and large classifications. FIG. 7 is a screenshot taken from an embodiment of the invention in which a user inputs ranges of numbers of records associated with each of the three classifications. It should be noted that user input can be specified at various levels of a healthcare organization.

It should be noted that the minimum value for the number of records in a patient record to be classified as small is always zero, while the maximum number of records in a patient records to be classified as large is always infinite. Other range bounds can be user specified, although it should be noted that constraints are imposed such that the minimum number of records within a patient record to be classified as medium is always one more than the maximum number of records within a patient record to be classified as small. Similar constraints apply as between the medium and large classifications. In this way it can be seen that a contiguous range is defined such that all records will fall into exactly one classification.

Convenient mechanisms for receiving and processing input data are now described. Referring first to FIG. 8 there is illustrated a graphical user interface (GUI) configured to receive input data in healthcare environments. It can be seen that the GUI comprises three tool bars 40, 41, 42 which are used to affect the input of data into a free text data input portion 43. The tool bars 40, 41 comprises various buttons which control such things as font, font size, font style (e.g. bold, italic, underline), text justification, and spell check. The tool bar 42 provides a search function to search for text within the text data input portion 43.

It can be seen that the text data input portion 43 is, in general terms configured to receive free text input. It can also be seen that the text data input portion can further accept images as input data, as shown by the image 44 in FIG. 8.

Textual data input using the text data input portion 43 can be arranged using headings, in a conventional manner. However, in preferred embodiments headings are processed so as to determine how to process input textual data as a whole. For example, referring to FIG. 9, it can be seen that a user has input text data “pc”. This textual input data has automatically been converted to the text “presenting complaints”. Further textual data subsequently entered under the heading “presenting complaints” can be stored in a database of the type described above in such a manner as to indicate complaints with which a patient presented. That is, the “presenting complaints” heading is used determine how and where subsequently entered textual data should be stored in the database.

It was explained that the heading “presenting complaints” was generated by input of the textual data “pc”. FIG. 10 shows an alternative embodiment. Here a list of headings 50 is presented to a user. A user can select headings from the list 50 for inclusion in the text data input portion 43. This can be achieved in any convenient manner, for example using “drag and drop” functionality. Headings input in this way can be processed in the manner described above.

FIG. 11 shows tags being used to assist in data input. In the illustrated example, a user has input text “ecg” resulting in the display of a list 51 representing ECG data for a patient for whom data is currently being input. The user can select one of the data items from the list 51 to be included in the textual data input portion 43, either directly or by way of a reference.

The textual input “ecg” and the list 51 are one example of a way in which data input is greatly aided. Specifically, by processing input data (in this case “ecg”) to identify a class of data (in this case ECG test results) a medical practitioner can more quickly enter data relating to a patient, obtaining other related data in a rapid and convenient manner as data entry progresses.

Similarly, it can be seen that the displayed text includes a blood pressure reading. This can again be input by typing “blood pressure” or an other appropriate text string, being presented with blood pressure readings, and causing these to be inserted in the text input portion 43.

Although embodiments of the invention have been described above, it will be appreciated that various modifications can be made to the described embodiments without departing from the spirit and scope of the appended claims. In particular, where embodiments of the invention have been described as having particular applicability in healthcare, the invention is not restricted to such applications, but is instead widely applicable.

1. A computer implemented method of presenting information indicating a quantity of data held in a healthcare data system relating to a patient, the method comprising:
determining, by a processor in a computing apparatus, a respective threshold range for each class in a predetermined set of classes;
processing, by the processor in the computer apparatus, healthcare data associated with said patient to classify said patient into one of a predetermined set of classes, wherein said processing comprises:
sending, to a computing system, data describing a patient identifier that references said patient, wherein the computing system is configured to use a hashing algorithm to identify one or more data stores that store data for said patient based at least in part on the patient identifier;
receiving, from the computing system, data referencing the one or more data stores that are managed by one or more computing systems;
determining a set of database tables to be queried from the one or more data stores for evaluating a rate of complexity of said patient's medical history;
querying the set of database tables in said healthcare data system to identify data items associated with said patient, wherein each database table is queried based at least in part on a primary key that references the patient, and wherein at least one of the database tables includes a corresponding foreign key field that references the primary key;
counting said data items identified by the one or more computing systems in the healthcare data system to generate a number;
determining that the number is within a threshold range corresponding to a first class in the predetermined set of classes;
classifying said patient into the first class based at least in part on said number, the first class representing an amount of complexity with respect to a medical history of said patient; and
providing, for display through the computing apparatus, a visual representation indicating the amount of complexity with respect to the medical history of said patient based on the first class.

2. A method according to claim 1, wherein each of said classes has an associated icon, and displaying data indicating said selected class comprises displaying said icon associated with said selected class.

3. A method according to claim 2, further comprising:
displaying, on said display in said computer apparatus, the icons of each of said predetermined set of classes, wherein said icon associated with said selected class is displayed in a first state, and said icons of the or each other class of said predetermined set of classes are displayed in a second state, said icon displayed in said first state being more prominently displayed than the or each icon displayed in said second state.

4. A method according to claim 3, wherein icons displayed in said second state are displayed greyed out.

5. A method according to claim 1, further comprising:
receiving, by said processor, user input data defining a range represented by at least one of said predetermined set of classes.

6. A method according to claim 5, further comprising receiving, by said processor, user input data defining a range represented by each of said predetermined set of classes.

7. A method according to claim 1, wherein said ranges represented by said predetermined set of classes together form a contiguous range.

8. A method according to claim 1, further comprising:
receiving an indication of an abbreviated tag in a text data input portion presented on the display;
converting the tag into an unabbreviated heading; and
providing for display the unabbreviated heading.

9. A method according to claim 8, further comprising:
storing entered textual data associated with the tag based on the heading.

10. A method according to claim 8, wherein the receiving an indication of an abbreviated tag comprises:
causing a list of headings to be presented on the display; and
receiving a selection of at least one heading in the list of headings by a drag and drop gesture.

11. A method according to claim 8, wherein the receiving an indication of an abbreviated tag comprises:
receiving a textual input of the tag.

12. A method according to claim 8, further comprising:
causing data about the patient associated with the tag to be automatically displayed as a list of patient data items.

13. A method according to claim 12, further comprising:
receiving selection of one item from the list of patient data items for display in the text data input portion.

14. A non-transitory computer readable storage medium carrying computer readable program code configured to cause a computer to carry out a method of presenting information indicating a quantity of data held in a healthcare data system relating to a patient, the method comprising:
determining a respective threshold range for each class in a predetermined set of classes;
processing healthcare data associated with said patient to classify said patient into one of a predetermined set of classes, wherein said processing comprises:
sending, to a computing system, data describing a patient identifier that references said patient, wherein the computing system is configured to use a hashing algorithm to identify one or more data stores that store data for said patient based at least in part on the patient identifier;
receiving, from the computing system, data referencing the one or more data stores that are managed by one or more computing systems;
determining a set of database tables to be queried from the one or more data stores for evaluating a rate of complexity of said patient's medical history;
querying the set of database tables in said healthcare data system to identify data items associated with said patient, wherein each database table is queried based at least in part on a primary key that references the patient, and wherein at least one of the database tables includes a corresponding foreign key field that references the primary key;
counting said data items identified by the one or more computing systems in the healthcare data system to generate a number;
determining that the number is within a threshold range corresponding to a first class in the predetermined set of classes;
classifying said patient into the first class based at least in part on said number, the first class representing an amount of complexity with respect to a medical history of said patient; and
providing, for display through the computing apparatus, a visual representation indicating the amount of complexity with respect to the medical history of said patient based on the first class.

15. A non-transitory computer readable storage medium according to claim 14 further comprising:
receiving an indication of an abbreviated tag in a text data input portion presented on the display;
converting the tag into an unabbreviated heading; and
providing for display the unabbreviated heading.

16. A non-transitory computer readable storage medium according to claim 15, further comprising:
storing entered textual data associated with the tag based on the heading.

17. A non-transitory computer readable storage medium according to claim 15, wherein the receiving an indication of an abbreviated tag comprises:
causing a list of headings to be presented on the display; and
receiving a selection of at least one heading in the list of headings by a drag and drop gesture.

18. A computer apparatus for presenting information indicating a quantity of data held in a healthcare data system relating to a patient, the apparatus comprising:
a program memory storing processor readable instructions; and
a processor configured to read and execute instructions stored in said program memory;
wherein said processor readable instructions comprise instructions configured to cause the processor to carry out a method, the method comprising:
determining a respective threshold range for each class in a predetermined set of classes;
processing healthcare data associated with said patient to classify said patient into one of a predetermined set of classes associated with said patient, each class representing a range of numbers of data items, wherein said processing comprises:
sending, to a computing system, data describing a patient identifier that references said patient, wherein the computing system is configured to use a hashing algorithm to identify one or more data stores that store data for said patient based at least in part on the patient identifier;
receiving, from the computing system, data referencing the one or more data stores that are managed by one or more computing systems;
determining a set of database tables to be queried from the one or more data stores for evaluating a rate of complexity of said patient's medical history;
querying the set of database tables in said healthcare data system to identify data items associated with said patient, wherein each database table is queried based at least in part on a primary key that references the patient, and wherein at least one of the database tables includes a corresponding foreign key field that references the primary key;
counting said data items identified by the one or more computing systems in the healthcare data system to generate a number;
determining that the number is within a threshold range corresponding to a first class in the predetermined set of classes;
classifying said patient into the first class based at least in part on said number, the class representing an amount of complexity with respect to a medical history of said patient; and
providing, for display through the computing apparatus, a visual representation indicating the amount of complexity with respect to the medical history of said patient based on the first class.

19. A computer apparatus according to claim 18, further comprising:
receiving an indication of an abbreviated tag in a text data input portion presented on the display;
converting the tag into an unabbreviated heading; and
providing for display the unabbreviated heading.

20. A computer apparatus according to claim 19, further comprising:
storing entered textual data associated with the tag based on the heading.
